(19) United States
(12) Patent Application Publication
(10) Pub. No.: US 2023/0043325 A1
(43) Pub. Date: Feb. 9, 2023

(54) COMPRESSION ASSEMBLY FOR SECURING INSIDE A BICYCLE SEAT POST

(71) Applicant: Jesus R. Enriquez, Bisbee, AZ (US)

(72) Inventor: Jesus R. Enriquez, Bisbee, AZ (US)

(21) Appl. No.: 17/817,932

(22) Filed: Aug. 5, 2022

Related U.S. Application Data
(60) Provisional application No. 63/230,373, filed on Aug. 6, 2021.

(51) Int. Cl. B62J 9/14; B62J 9/40

(52) U.S. Cl. CPC B62J 9/14; B62J 9/40

(57) ABSTRACT

The present invention relates to a compression assembly for allowing an inner post to be securely disposed in an outer post, such as a bicycle seat post. The compression assembly comprises a connecting assembly for connecting the compression assembly to the inner post, an expanding component, and an expander component attached to a surface of the expanding component. Actuating the expander component in a first mode may cause the expanding component swell, and actuating the expander component in a second mode may cause the expanding component shrink. The first mode may prevent the inner post from being removed from the outer post. The second mode may allow the inner post to be removed from the outer post.

### CROSS-REFERENCES TO RELATED APPLICATIONS

This application is a non-provisional and claims benefit of U.S. Provisional Application No. 63/230,373 filed Aug. 6, 2021, the specification(s) of which is/are incorporated herein in their entirety by reference.

### FIELD OF THE INVENTION

The present invention relates to a compression assembly for allowing an inner post to be securely disposed in a bicycle seat post.

### BACKGROUND OF THE INVENTION

Cycling is a popular form of transport, exercise, recreation, and sport. One problem of riding a bicycle is the common occurrence of a flat bicycle tire. Repair of the flat bike tire is inconvenient, especially when the flat bike tire occurs during a ride. A bicycle rider typically carries a tire repair kit having a tire pump, tire tools, and a tire patch. The tire repair kit may be carried by the rider or attached to the bike frame, which adds bulk and weight to the bicycle. Moreover, the use of the tire pump to inflate a bike tire is both time consuming and exhausting. One would need to exert a lot of energy to pump the tire to the proper tire pressure, which may be as high as 130 psi for road bike tires. Since the tire pump is usually mounted to the bicycle frame, the tire pump could be stolen or accidentally detached and lost during a ride.

One alternative to the tire pump is to use a high-pressure gas cartridge, such as a CO₂ cartridge, to inflate the flat tire. These gas cartridges are small and convenient to carry during a ride, and significantly reduce inflation time and effort. However, these gas cartridges would still need to be carried in the bulky tire repair kit. Hence, there is a need for a bicycle tire repair system that is convenient for transport and can efficiently inflate a flat bike tire.

These bicycle tire repair systems, while useful, can be difficult to easily transport. Prior systems may incorporate these repair systems into a bicycle seat post, complete with a seat, replacing the original bicycle seat post and disposed in a bicycle frame. However, this requires a seat and seat post to be included with every bicycle tire repair system in order to actually use and transport it efficiently. Thus, there exists a present need for a component that allows a bicycle tire repair system to be easily transported and incorporated into a pre-existing bicycle seat post.

### BRIEF SUMMARY OF THE INVENTION

It is an objective of the present invention to provide devices and methods that allow for securely disposing an inner post in a bicycle seat post through use of a compression assembly, as specified in the independent claims. Embodiments of the invention are given in the dependent claims. Embodiments of the present invention can be freely combined with each other if they are not mutually exclusive.

According to some embodiments, the present invention features a compression assembly capable of securing an inner post within an outer post. The compression assembly may comprise a connecting assembly for connecting the compression assembly to the inner post, an expanding component, and an expander component attached to a surface of the expanding component. In some embodiments, the expander component is operatively coupled to the connecting assembly. Actuating the expander component in a first mode may cause the expanding component to swell, and actuating the expander component in a second mode may cause the expanding component to shrink. The first mode may prevent the inner post from being removed from the outer post. The second mode may allow the inner post to be removed from the outer post.

According to other embodiments, the present invention features a method for securing an inner post within an outer post through use of a compression assembly. The method may comprise providing the compression assembly. The compression assembly may comprise a connecting assembly for connecting the compression assembly to the inner post, an expanding component, and an expander component attached to a surface of the expanding component. In some embodiments, the expander component is operatively coupled to the connecting assembly. Actuating the expander component in a first mode may cause the expanding component to swell, and actuating the expander component in a second mode may cause the expanding component to shrink. The first mode may prevent the inner post from being removed from the outer post. The second mode may allow the inner post to be removed from the outer post. The method may further comprise connecting the compression assembly to a first end of the inner post, fitting the first end of the inner post into the outer post, and actuating the expander component in the first mode such that the inner post is prevented from being removed from the outer post.

One of the unique and inventive technical features of the present invention is the material used and the design of the compression system that allow securing of the components with relative ease. Without wishing to limit the invention to any theory or mechanism, it is believed that the technical feature of the present invention advantageously provides for ease of use and security. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S

The features and advantages of the present invention will become apparent from a consideration of the following detailed description presented in connection with the accompanying drawings in which:

FIG. 1A shows an isometric view of the compression assembly of the present invention connected to an inner post and showing the scale of the invention to a human hand.

FIG. 1B shows an expanded view of an inner post (in this case a bicycle repair assembly) with the compression assembly attached.

FIG. 1C shows a side view of attaching the compression assembly to the inner post.

FIG. 1D shows a side view of the compression assembly fully attached to the inner post.

FIG. 2 shows a flow chart of a method of securing an inner post within an outer post through use of a compression assembly.

FIG. 3 shows an example of an inner post (e.g. a bicycle repair assembly) and an outer post (e.g. a bicycle seat post).

### DETAILED DESCRIPTION OF THE INVENTION

Following is a list of elements corresponding to a particular element referred to herein:

100 compression assembly

110 connecting assembly

120 expander component

130 expanding component

200 inner post

300 outer post

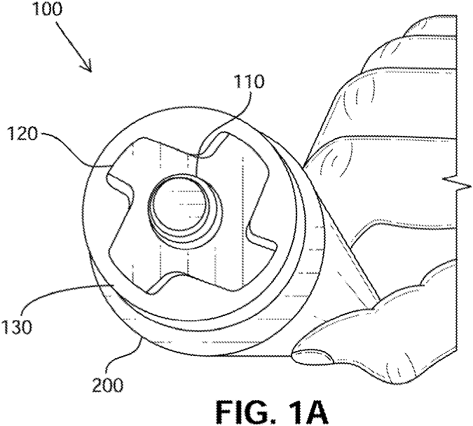

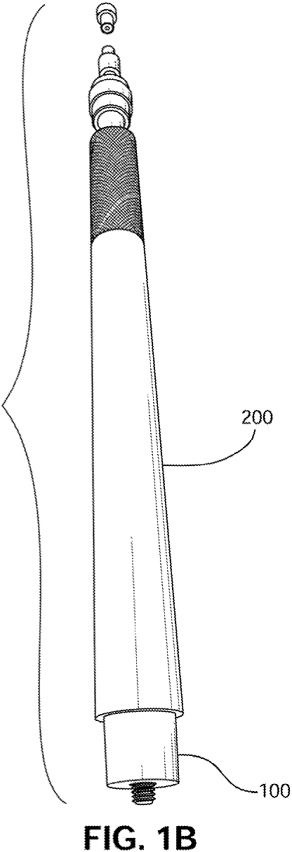

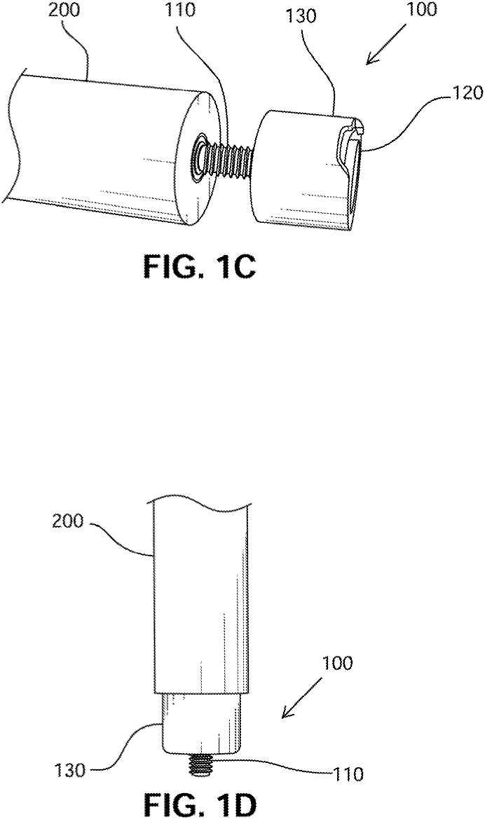

Referring now to FIGS. 1A-1D, the present invention features a compression assembly (100) capable of securing an inner post (200) within an outer post (300). The compression assembly (100) may comprise a connecting assembly (110) capable of connecting the compression assembly (100) to the inner post (200), and an expanding component (130). In some embodiments, the connecting assembly (110) may be disposed within the expanding component (130). The compression assembly (100) may further comprise an expander component (120) disposed on and attached to a surface of the expanding component (130). In some embodiments, the expander component (120) is operatively coupled to the connecting assembly (110).

According to some embodiments, actuating the expander component (120) in a first mode may cause the expanding component (130) to increase in diameter. Actuating the expander component (120) in a second mode may cause the expanding component (130) to decrease in diameter. Actuating the expander component (120) in a first mode while the compression assembly (100) is disposed within the outer post (300) may prevent the inner post (200) from being removed from the outer post (300). Actuating the expander component (120) in a second mode while the compression assembly (100) is disposed within the outer post (300) may allow the inner post (200) to be removed from the outer post (300).

In some embodiments, the connecting assembly (110) may comprise a threaded screw and a threaded hole configured to be compatible with the threaded screw. The expander component (120) may be in-line with the threaded hole of the connecting assembly (110). Twisting the threaded screw into the threaded hole may actuate the expander component (120) in the first mode, and twisting the threaded screw out of the threaded hole may actuate the expander component (120) in the second mode.

In some embodiments, the expander component (120) may comprise a flat washer having a plurality of spikes disposed on top of the expanding component (130). The plurality of spikes may curve in the same direction. In some embodiments, the expanding component (130) may comprise a cylinder. In some embodiments, a material of the expanding component (130) may comprise rubber or non-corrosive rubber material. In some embodiments, the inner post (200) may comprise a bicycle repair assembly. In a non-limiting example, the bicycle repair assembly is disposed in an interior compartment of the inner post. In some embodiments, the bicycle repair assembly may include tire tools, one or more tire patches, and a tire pump and/or a CO₂ cartridge.

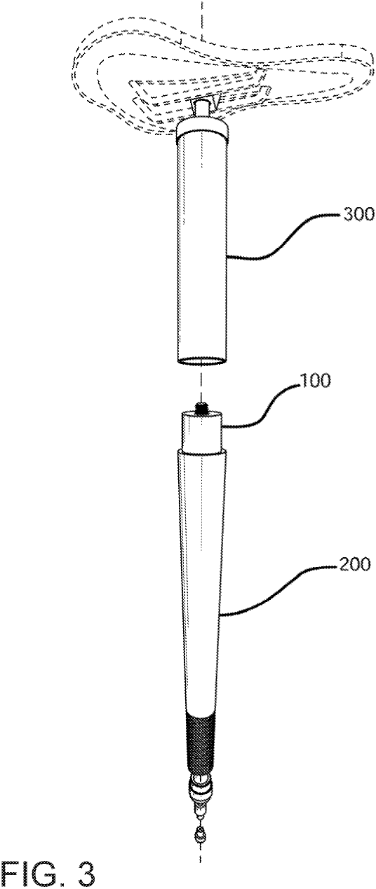

As shown in FIG. 3, the outer post (300) may comprise a bicycle seat post. A first end of the inner post (200) may comprise the compression assembly (100) and be disposed within the outer post (300), and a second end of the inner post (200) may be disposed in a bicycle frame.

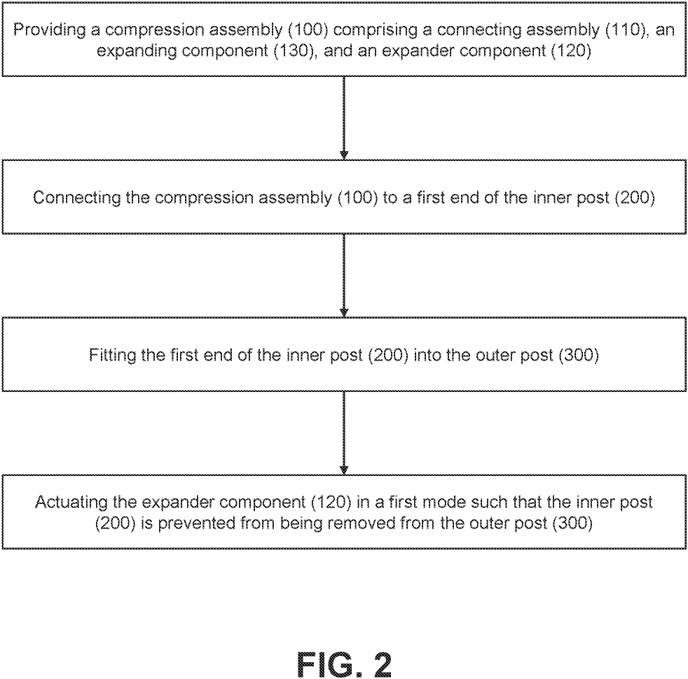

Referring now to FIG. 2, the present invention features a method for securing an inner post (200) within an outer post (300) through use of a compression assembly (100). In some embodiments, the method may comprise providing the compression assembly (100). The compression assembly (100) may comprise a connecting assembly (110) capable of connecting the compression assembly (100) to the inner post (200), and an expanding component (130). In some embodiments, the connecting assembly (110) may be disposed within the expanding component (130). The compression assembly (100) may further comprise an expander component (120) disposed on and attached to a surface of the expanding component (130).

In some embodiments, the expander component (120) is operatively coupled to the connecting assembly (110). Actuating the expander component (120) in a first mode may cause the expanding component (130) to increase in diameter. Actuating the expander component (120) in a second mode may cause the expanding component (130) to decrease in diameter. Actuating the expander component (120) in a first mode while the compression assembly (100) is disposed within the outer post (300) may prevent the inner post (200) from being removed from the outer post (300). Actuating the expander component (120) in a second mode while the compression assembly (100) is disposed within the outer post (300) may allow the inner post (200) to be removed from the outer post (300).

In some embodiments, as shown in FIG. 3, the method may further comprise connecting the compression assembly (100) to a first end of the inner post (200), fitting the first end of the inner post (200) into the outer post (300), and actuating the expander component (120) in the first mode such that the inner post (200) is prevented from being removed from the outer post (300).

In some embodiments, the connecting assembly (110) may comprise a threaded screw and a threaded hole configured to be compatible with the threaded screw. The expander component (120) may be in-line with the threaded hole of the connecting assembly (110). Twisting the threaded screw into the threaded hole may actuate the expander component (120) in the first mode, and twisting the threaded screw out of the threaded hole may actuate the expander component (120) in the second mode.

In some embodiments, the expander component (120) may comprise a flat washer having a plurality of spikes disposed on top of the expanding component (130). The plurality of spikes may curve in the same direction. In some embodiments, the expanding component (130) may comprise a cylinder. In some embodiments, a material of the expanding component (130) may comprise rubber or non-corrosive rubber material. In some embodiments, the inner post (200) may comprise a bicycle repair assembly. In a non-limiting example, the bicycle repair assembly is disposed in an interior compartment of the inner post. The bicycle repair assembly may include tire tools, one or more tire patches, and a tire pump and/or a CO₂ cartridge. In some embodiments, the outer post (300) may comprise a bicycle seat post. A second end of the inner post (200) may be disposed in a bicycle frame.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A compression assembly (100) capable of securing an inner post (200) within an outer post (300), the compression assembly (100) comprising:
a. a connecting assembly (110) capable of connecting the compression assembly (100) to the inner post (200);
b. an expanding component (130), wherein the connecting assembly (110) is disposed within the expanding component (130); and
c. an expander component (120) disposed on and attached to a surface of the expanding component (130), wherein actuating the expander component (120) in a first mode causes the expanding component (130) to increase in diameter, wherein actuating the expander component (120) in a second mode causes the expanding component (130) to decrease in diameter;
wherein actuating the expander component (120) in the first mode while the compression assembly (100) is disposed within the outer post (300) prevents the inner post (200) from being removed from the outer post (300);
wherein actuating the expander component (120) in the second mode while the compression assembly (100) is disposed within the outer post (300) allows the inner post (200) to be removed from the outer post (300).

2. The compression assembly (100) of claim 1, wherein the connecting assembly (110) comprises a threaded screw and a threaded hole configured to be compatible with the threaded screw.

3. The compression assembly (100) of claim 2, wherein the expander component (120) is in-line with the threaded hole of the connecting assembly (110).

4. The compression assembly (100) of claim 3, wherein twisting the threaded screw into the threaded hole actuates the expander component (120) in the first mode, wherein twisting the threaded screw out of the threaded hole actuates the expander component (120) in the second mode.

5. The compression assembly (100) of claim 1, wherein the expander component (120) comprises a flat washer having a plurality of spikes disposed on top of the expanding component (130), wherein the plurality of spikes curve in a same direction.

6. The compression assembly (100) of claim 1, wherein the expanding component (130) comprises a cylinder.

7. The compression assembly (100) of claim 6, wherein a material of the expanding component (130) comprises rubber.

8. The compression assembly (100) of claim 1, wherein the inner post (200) comprises a bicycle repair assembly.

9. The compression assembly (100) of claim 8, wherein the bicycle repair assembly is disposed in an interior compartment of the inner post.

10. The compression assembly (100) of claim 8, wherein the outer post (300) comprises a bicycle seat post.

11. The compression assembly (100) of claim 10, wherein a first end of the inner post (200) comprises the compression assembly (100) and is disposed within the outer post (300), and wherein a second end of the inner post (200) is disposed in a bicycle frame.

12. A method for securing an inner post (200) within an outer post (300) through use of a compression assembly (100), the method comprising:
a. providing the compression assembly (100), the compression assembly (100) comprising:
i. a connecting assembly (110) capable of connecting the compression assembly (100) to the inner post (200);
ii. an expanding component (130), wherein the connecting assembly (110) is disposed within the expanding component (130); and
iii. an expander component (120) disposed on and attached to a surface of the expanding component (130), wherein actuating the expander component (120) in a first mode causes the expanding component (130) to increase in diameter, wherein actuating the expander component (120) in a second mode causes the expanding component (130) to decrease in diameter;
wherein actuating the expander component (120) in the first mode while the compression assembly (100) is disposed within the outer post (300) prevents the inner post (200) from being removed from the outer post (300);
wherein actuating the expander component (120) in the second mode while the compression assembly (100) is disposed within the outer post (300) allows the inner post (200) to be removed from the outer post (300);
b. connecting the compression assembly (100) to a first end of the inner post (200);
c. fitting the first end of the inner post (200) into the outer post (300); and
d. actuating the expander component (120) in the first mode such that the inner post (200) is prevented from being removed from the outer post (300).

13. The method of claim 12, wherein the connecting assembly (110) comprises a threaded screw and a threaded hole configured to be compatible with the threaded screw.

14. The method of claim 13, wherein the expander component (120) is in-line with the threaded hole of the connecting assembly (110), wherein twisting the threaded screw into the threaded hole actuates the expander component (120) in the first mode, wherein twisting the threaded screw out of the threaded hole actuates the expander component (120) in the second mode.

15. The method of claim 12, wherein the expander component (120) comprises a flat washer having a plurality of spikes disposed on top of the expanding component (130), wherein the plurality of spikes curve in the same direction.

16. The method of claim 12, wherein the expanding component (130) comprises a cylinder.

17. The method of claim 16, wherein a material of the expanding component (130) comprises rubber or non-corrosive rubber material.

18. The method of claim 12, wherein the inner post (200) comprises a bicycle repair assembly.

19. The method of claim 18, wherein the bicycle repair assembly is disposed in an interior compartment of the inner post.

20. The method of claim 18, wherein the outer post (300) comprises a bicycle seat post.
